(19) United States
(12) Patent Application Publication
(10) Pub. No.: US 2024/0012221 A1
(43) Pub. Date: Jan. 11, 2024

(54) OPTICAL SYSTEM, AND IMAGE PICKUP APPARATUS HAVING THE SAME

(71) Applicant: CANON KABUSHIKI KAISHA, Tokyo (JP)

(72) Inventor: Akira MIZUMA, Saitama (JP)

(21) Appl. No.: 18/329,794

(22) Filed: Jun. 6, 2023

(30) Foreign Application Priority Data
Jul. 11, 2022 (JP) 2022-110998

(51) Int. Cl. G02B 9/08; G02B 15/14; G02B 15/15; G02B 13/18

(52) U.S. Cl. CPC G02B 9/08; G02B 15/144511; G02B 15/145523; G02B 15/1461; G02B 15/145121; G02B 15/15; G02B 13/18

(57) ABSTRACT

In an optical system, a height from an optical axis of a paraxial marginal ray that passes through a lens surface closest to an object is smaller than a maximum height from the optical axis of the paraxial marginal ray that passes through a lens surface on an image side of an intersection between the optical axis and a paraxial chief ray. The optical system includes an optical element disposed on an object side or the image side of the intersection. The optical element has positive refractive power in a case where the optical element is disposed on the object side of the intersection, and has negative refractive power in a case where the optical element is disposed placed on the image side of the intersection. A predetermined condition is satisfied.

### BACKGROUND

### Technical Field

One of the aspects of the disclosure relates generally to an optical system, and more particularly to an optical system suitable for a digital video camera, a digital still camera, a broadcasting camera, a film-based camera, a surveillance camera, and the like.

### Description of Related Art

A retrofocus type optical system has recently been used as an imaging optical system with a wide angle of view. The retrofocus type optical system has lateral chromatic aberration larger than longitudinal chromatic aberration. Japanese Patent Laid-Open No. 2020-166263 discloses an optical system that uses an optical material that exhibits large dispersion and anomalous partial dispersion in order to correct chromatic aberration over a wide wavelength range.

However, as in the optical system disclosed in Japanese Patent Laid-Open No. 2020-166263, in a case where low-refraction and low-dispersion glass such as fluorite is used, chromatic aberration does not change by a predetermined amount or more unless the refractive power of the lens surface is significantly changed. Therefore, in a case where the chromatic aberration is sufficiently corrected, the Petzval sum becomes too large in the positive direction, and the correction of the curvature of field becomes insufficient. In addition, the optical system disclosed in Japanese Patent Laid-Open No. 2020-166263 uses a high refractive index and high dispersion material for a negative lens to correct the chromatic aberration, but cannot satisfactorily correct secondary (second-order) spectra of longitudinal and lateral chromatic aberrations.

### SUMMARY

In an optical system according to one aspect of the disclosure, a height from an optical axis of a paraxial marginal ray that passes through a lens surface closest to an object is smaller than a maximum height from the optical axis of the paraxial marginal ray that passes through a lens surface on an image side of an intersection between the optical axis and a paraxial chief ray. The optical system includes an optical element disposed on an object side or the image side of the intersection. The optical element has positive refractive power in a case where the optical element is disposed on the object side of the intersection, and has negative refractive power in a case where the optical element is disposed on the image side of the intersection. The following inequalities are satisfied:

1.70<Nd<1.85

28<νd<39

−0.010<θgF−(0.64168−0.00162×νd)<−0.004

where Nd is a refractive index for d-line of the optical element, νd is an Abbe number of the optical element, and θgF is a partial dispersion ratio for g-line and F-line of the optical element. An image pickup apparatus having the above optical system also constitutes another aspect of the disclosure.

Further features of the disclosure will become apparent from the following description of embodiments with reference to the attached drawings.

### BRIEF DESCRIPTION OF THE DRAWINGS

FIG. 1 is a sectional view of an optical system according to Example 1 in an in-focus state at infinity.

FIG. 2 is a longitudinal aberration diagram of the optical system according to Example 1 in the in-focus state at infinity.

FIG. 3 is a sectional view of an optical system according to Example 2 in an in-focus state at infinity.

FIGS. 4A, 4B, and 5C are longitudinal aberration diagrams of the optical system according to Example 2 in the in-focus state at infinity at a wide-angle end, an intermediate (middle) zoom position, and a telephoto end.

FIG. 5 is a sectional view of an optical system according to Example 3 in an in-focus state at infinity.

FIGS. 6A, 6B, and 6C are longitudinal aberration diagrams of the optical system according to Example 3 in the in-focus state at infinity at a wide-angle end, an intermediate (middle) zoom position, and a telephoto end.

FIG. 7 is a sectional view of an optical system according to Example 4 in an in-focus state at infinity.

FIGS. 8A, 8B, and 8C are longitudinal aberration diagrams of the optical system according to Example 4 in the in-focus state at infinity at a wide-angle end, an intermediate (middle) zoom position, and a telephoto end.

FIG. 9 is a sectional view of an optical system according to Example 5 in an in-focus state at infinity.

FIGS. 10A, 10B, and 10C are longitudinal aberration diagrams of the optical system according to Example 5 in the in-focus state at infinity at a wide-angle end, an intermediate (middle) zoom position, and a telephoto end.

FIG. 11 is a sectional view of an optical system according to Example 6 in an in-focus state at infinity.

FIGS. 12A, 12B, and 12C are longitudinal aberration diagrams of the optical system according to Example 6 in the in-focus state at infinity at a wide-angle end, an intermediate (middle) zoom position, and a telephoto end.

FIG. 13 is a schematic diagram of the paraxial refractive power arrangement of a retrofocus type optical system.

FIG. 14 is a schematic diagram of an image pickup apparatus.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

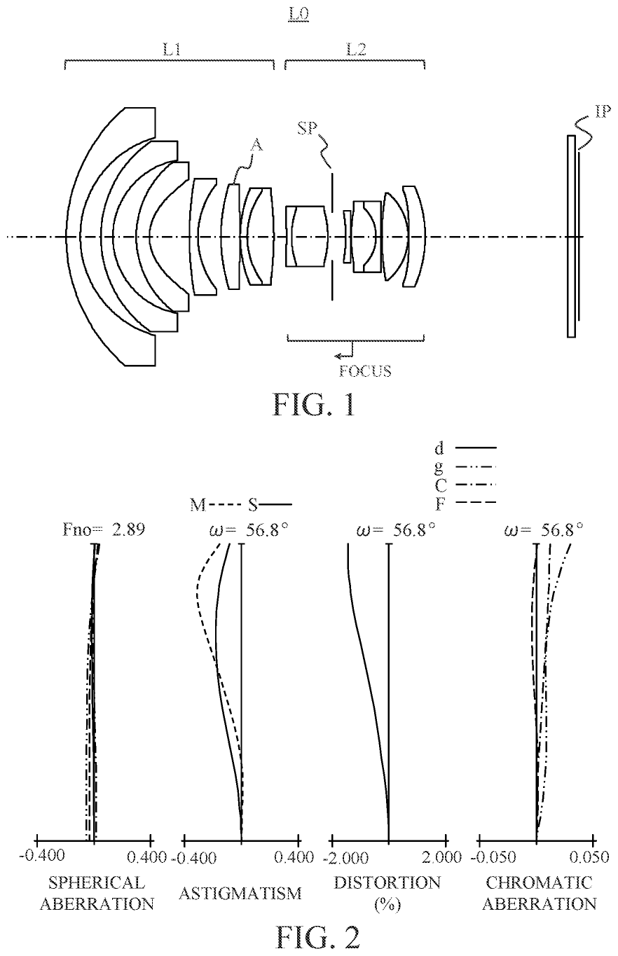

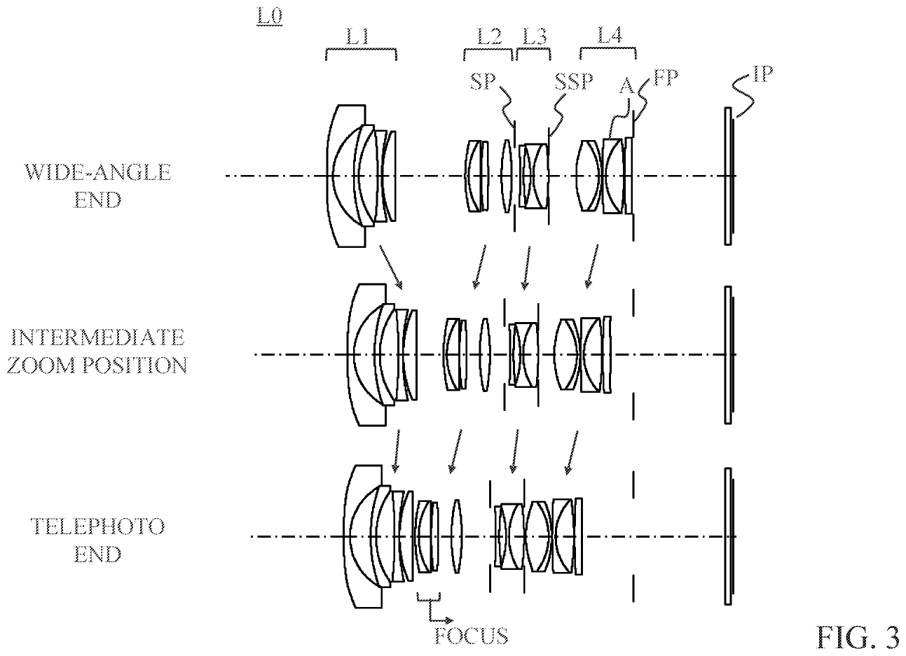

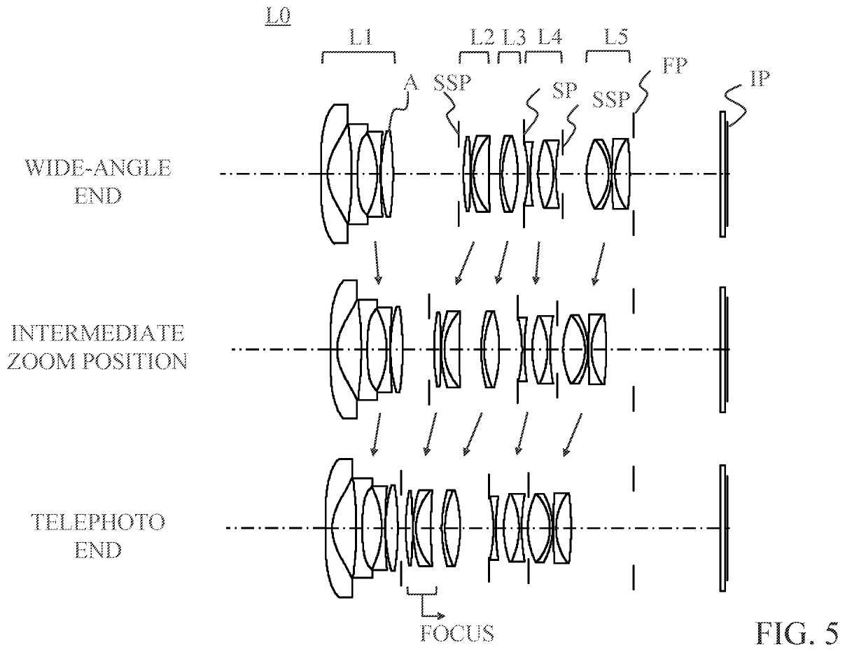

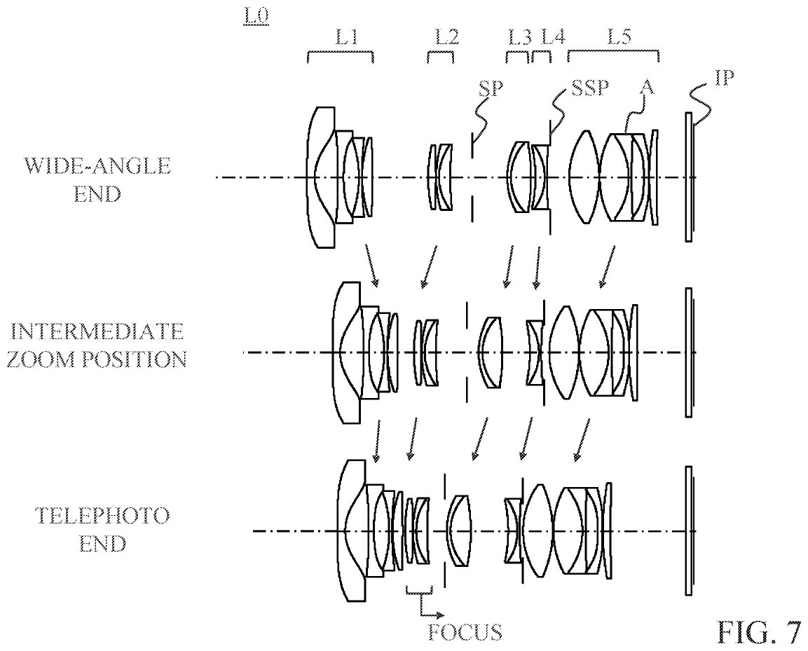

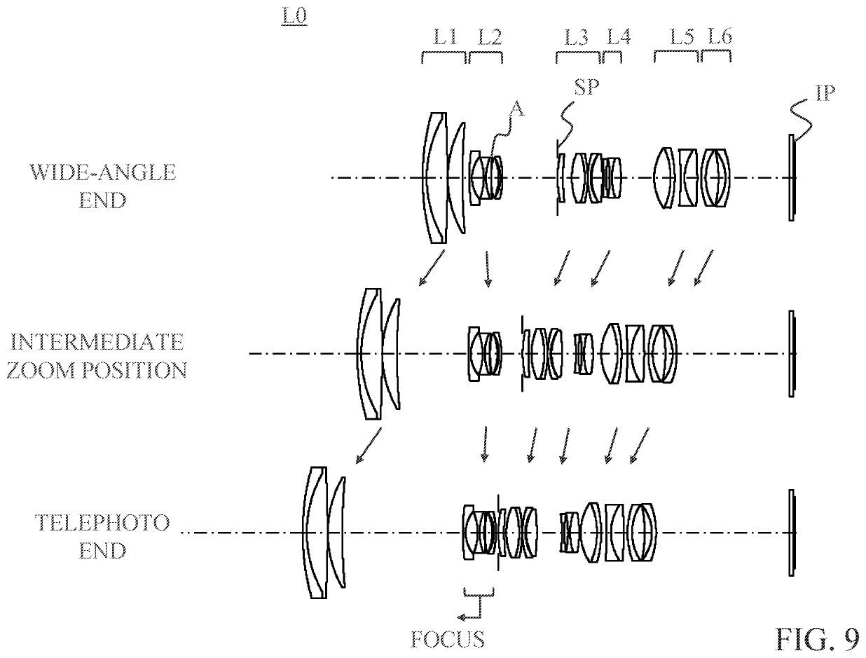

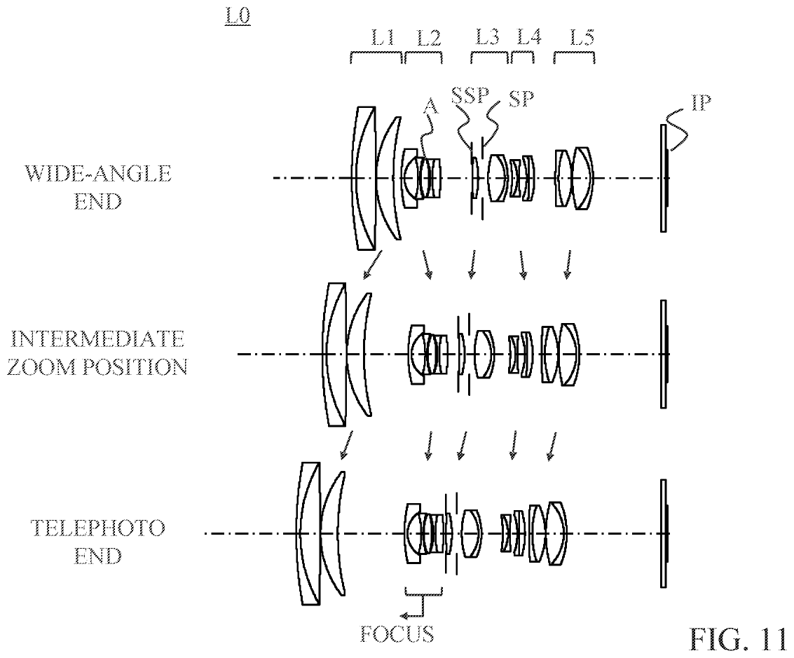

FIGS. 1, 3, 5, 7, 9, and 11 are sectional views of the optical systems L0 according to Examples 1 to 6, respectively, in in-focus states at infinity. The optical system L0 according to each example is used in an image pickup apparatus such as a digital video camera, a digital still camera, a broadcasting camera, a film-based camera, and a surveillance camera.

In each sectional view, a left side is an object side (enlargement side), and a right side is an image side (reduction side). The optical system L0 according to Example 1 is a fixed focal length focus lens, and the optical systems L0 according to Examples 2 to 6 are zoom lenses. The optical system L0 according to each example includes a plurality of lens units. In Examples 2 to 6, the lens unit is a group of lenses that integrally move or stand still during zooming. That is, in the optical systems L0 according to Examples 2 to 6, a distance between adjacent lens units changes during zooming. The sectional views of the optical systems L0 according to Examples 2 to 6 illustrate the positions of the lens units at the wide-angle ends, the telephoto ends, and the intermediate zoom positions. The wide-angle end and the telephoto end correspond to states in which each lens unit according to the optical system L0 is positioned at mechanically movable ends. The lens unit may include one or more lenses. The lens unit may include an aperture stop (diaphragm).

In each sectional view, Li represents an i-th (i is a natural number) lens unit counted from the object side among the lens units included in the optical system L0 according to each example.

SP denotes an aperture stop. IP denotes an image plane. In a case where the optical system L0 according to each example is used as an imaging optical system for a digital still camera or a digital video camera, an imaging plane of a solid-state image sensor (photoelectric conversion element) such as a CCD sensor or a CMOS sensor is placed on the image plane IP. In a case where the optical system L0 according to each example is used as an imaging optical system for a film-based camera, a photosensitive plane corresponding to the film plane is placed on the image plane IP. SSP denotes an auxiliary diaphragm for auxiliary limiting a light beam (luminous flux) of a maximum aperture. FP denotes a flare cutting diaphragm for cutting unnecessary light.

A lens indicated as “focus” in each sectional view is a lens that moves during focusing. An arrow illustrated together with “focus” indicates a moving direction during focusing from infinity to close. In the optical systems L0 according to Examples 2 to 6, each lens unit moves in a solid-line arrow direction during zooming from the wide-angle end to the telephoto end.

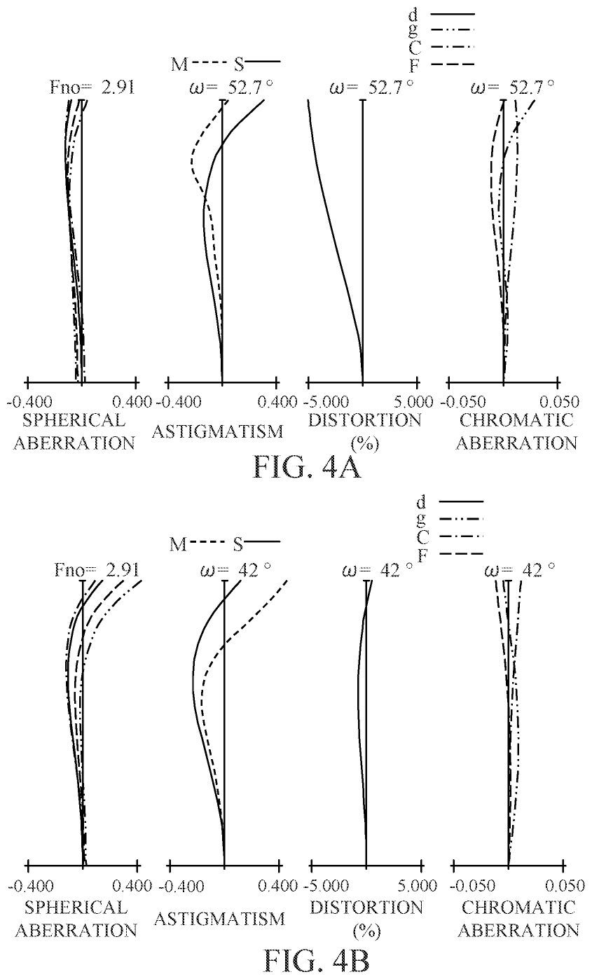

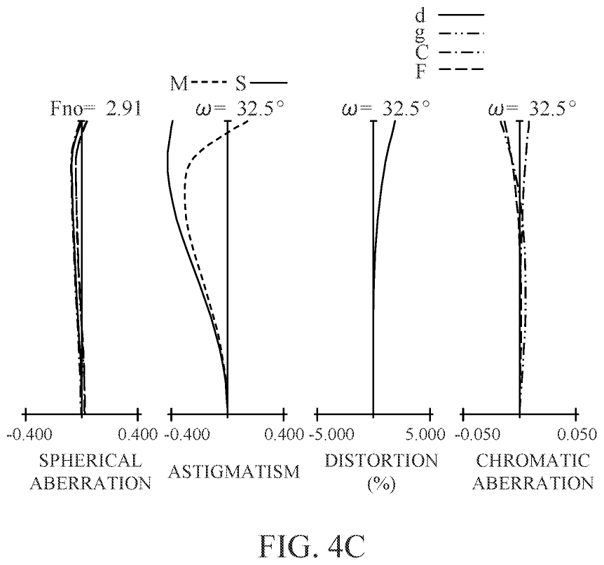

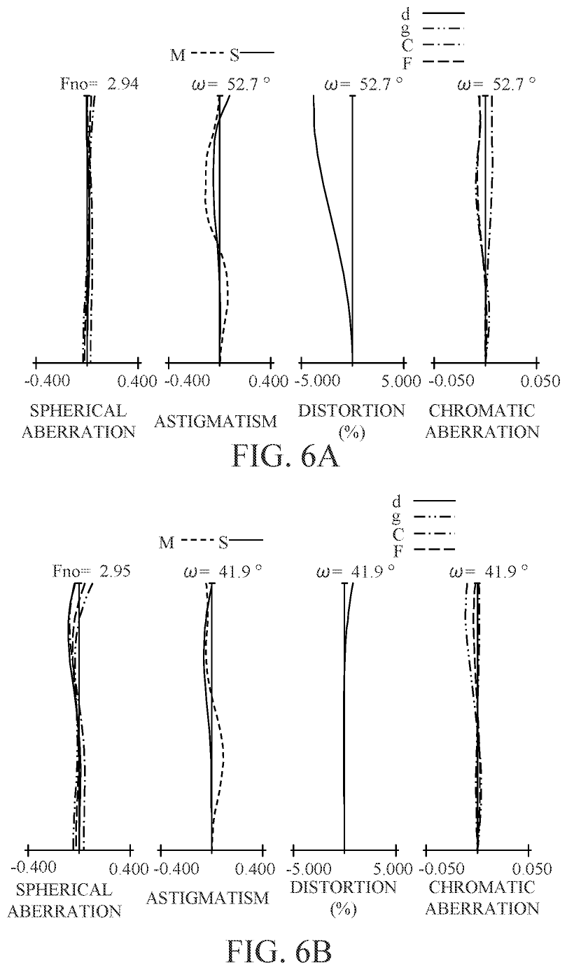

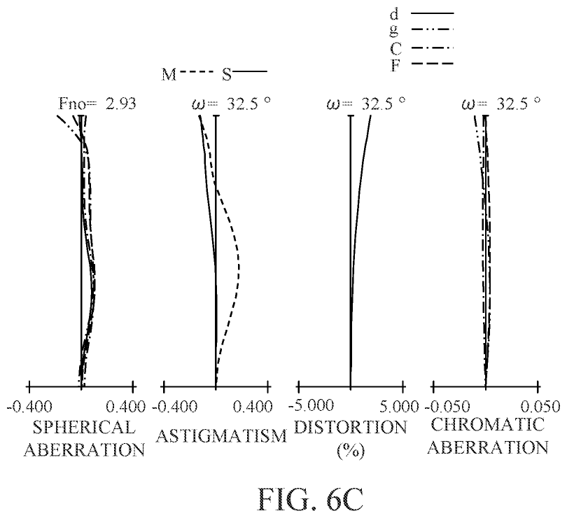

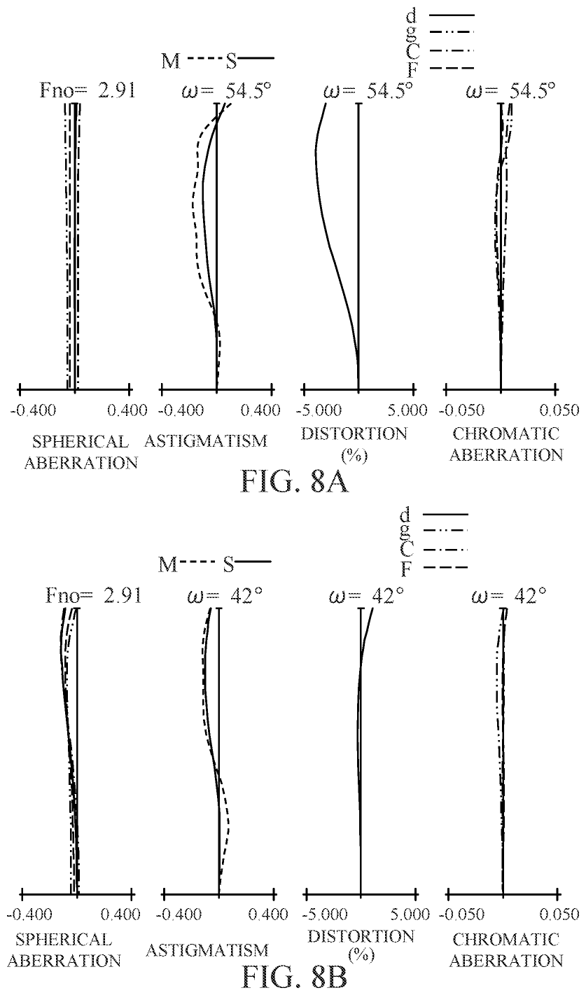

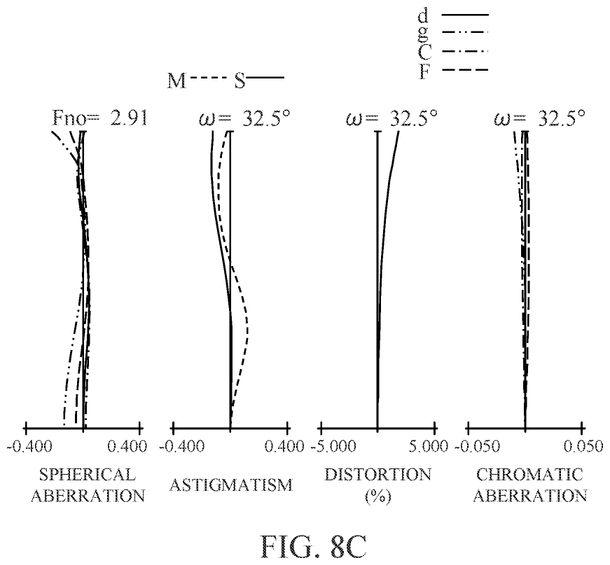

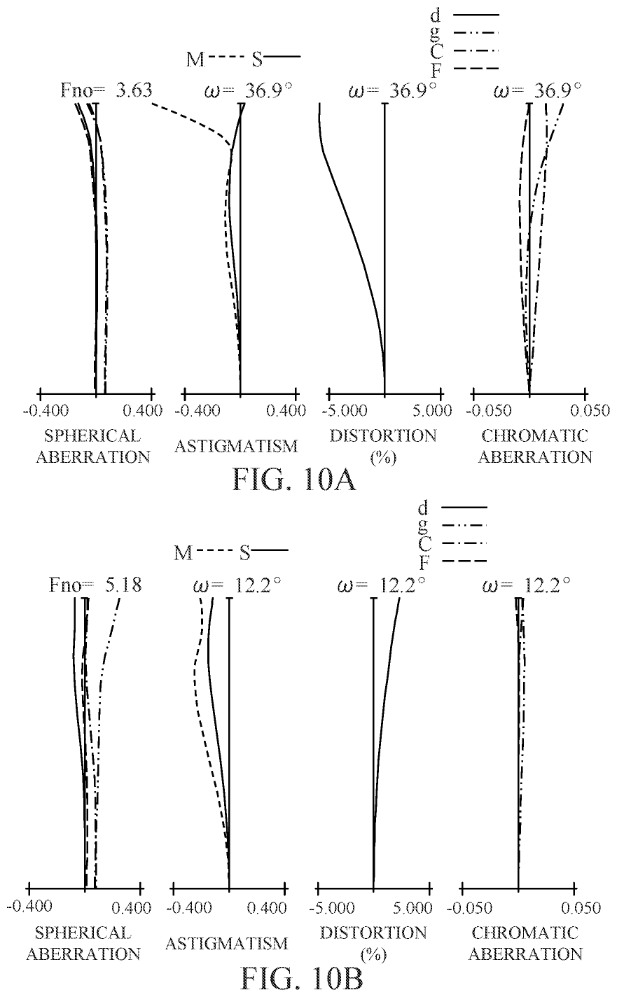

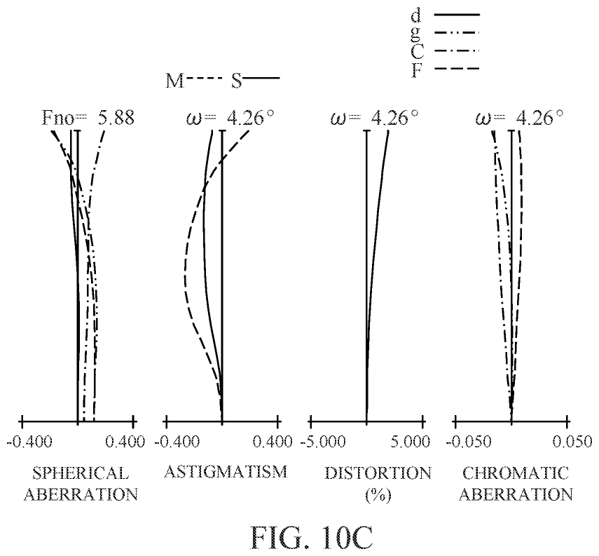

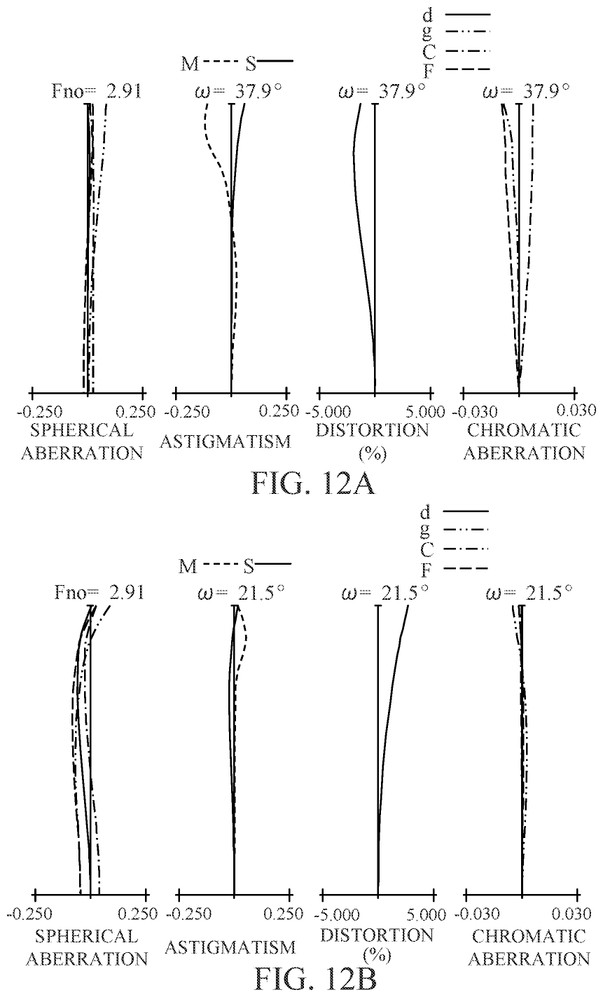

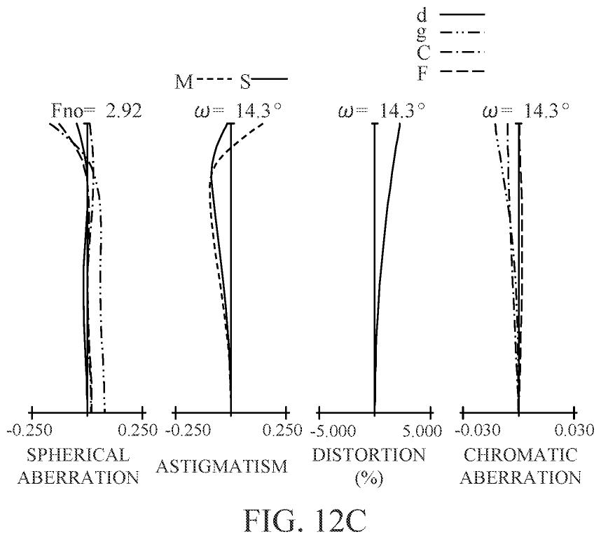

FIG. 2 is a longitudinal aberration diagram of the optical system L0 according to Example 1 in the in-focus state at infinity. FIGS. 4A, 6A, 8A, 10A, and 12A are aberration diagrams of the optical systems L0 according to Examples 2 to 6, respectively, in the in-focus states at infinity at the wide-angle ends. FIGS. 4B, 6B, 8B, 10B, and 12B are longitudinal aberration diagrams of the optical systems L0 according to Examples 2 to 6, respectively, in the in-focus states at infinity at the intermediate zoom positions. FIGS. 4C, 6C, 8C, 10C, and 12C are longitudinal aberration diagrams of the optical systems L0 according to Examples 2 to 6, respectively, in the in-focus states at infinity at the telephoto end.

In a spherical aberration diagram, FNo represents an F-number. The spherical aberration diagram illustrates spherical aberration amounts for the d-line (with a wavelength of 587.56 nm), g-line (with a wavelength of 435.835 nm), C-line (with a wavelength of 656.27 nm), and F-line (with a wavelength of 486.13 nm). In an astigmatism diagram, S denotes an astigmatism amount on a sagittal image plane, and M denotes an astigmatism amount on a meridional image plane. A distortion diagram illustrates a distortion amount for the d-line. A chromatic aberration diagram illustrates chromatic aberration amounts for the g-line, C-line, and F-line. ω is a half angle of view (degrees).

A description will now be given of a characteristic configuration of the optical system L0 according to each example.

The optical system L0 according to each example is a so-called wide-angle system or a high magnification zoom optical system including the wide-angle system. That is, in the optical system L0 according to each example, a height from the optical axis of a paraxial marginal ray passing through a lens surface closest to the object is smaller than a maximum height from the optical axis of the paraxial marginal ray passing through a lens surface on the image side of an intersection P between the optical axis and a paraxial chief ray. Such an optical system is called a retrofocus type optical system. In addition, in the optical system L0 according to each example, the height from the optical axis of the paraxial marginal ray passing through the lens surface closest to the object is smaller than the maximum height from the optical axis of the paraxial marginal ray passing through the lens surface on the image side of the aperture stop SP. In a case where the optical system L0 is a zoom lens, it may be configured to have the above configuration at the wide-angle end.

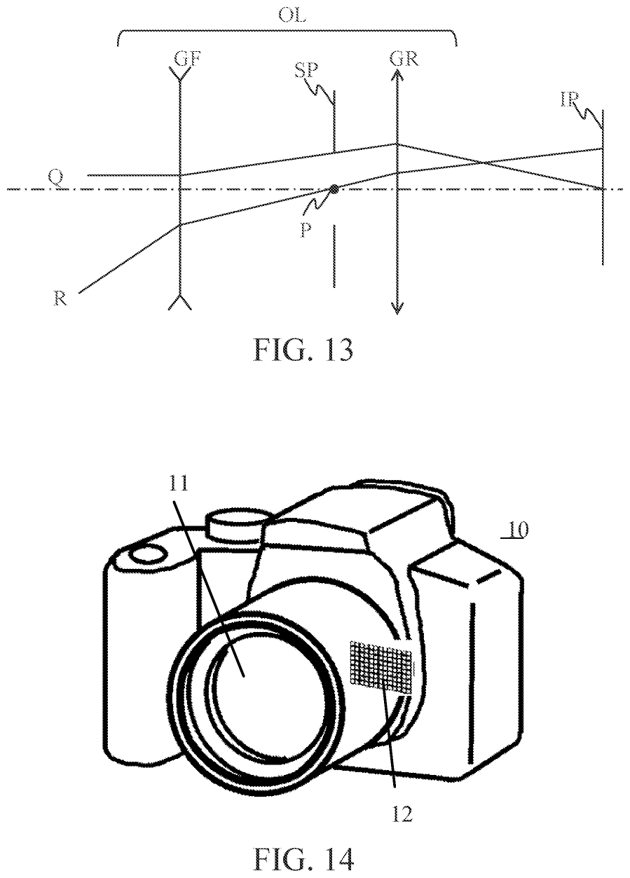

FIG. 13 schematically illustrates the paraxial refractive power arrangement of the retrofocus type optical system OL. In FIG. 13, GF denotes a front unit having negative refractive power, and GR denotes a rear unit having positive refractive power. In FIG. 13, Q denotes a paraxial marginal ray, and R is a paraxial chief ray. As illustrated in FIG. 13, the aperture stop SP is often disposed around the intersection P.

The paraxial marginal ray is a paraxial ray with a height of 1 from the optical axis and incident parallel to the optical axis of the optical system OL in a case where the focal length of the optical system OL is normalized to 1. In a case where the focal length of the optical system OL is normalized to 1, the paraxial chief ray is a paraxial ray passing through the intersection P between the entrance pupil and the optical axis of the optical system OL among the rays incident on the optical axis at an angle of −45°. The incident angle of the optical system OL is positive in a clockwise direction from the optical axis, and negative in a counterclockwise direction from the optical axis.

The optical system L0 according to each example includes an optical element (lens) A that satisfies inequalities (1) to (3), which will be described below. In Examples 1 to 6, the optical elements A are the fifth, fourteenth, fourth, fourteenth, sixth, and sixth lenses counted from the object side, respectively.

The optical system L0 according to each example satisfies the following inequalities (1) to (3):

1.70<Nd<1.85 (1)

28<νd<39 (2)

−0.010<θgF−(0.64168−0.00162×νd)<−0.004 (3)

where Nd is a refractive index of the optical element A for the d-line, νd is an Abbe number of the optical element A, θgF is a partial dispersion ratio of the optical element A for the g-line and F-line. The Abbe number νd and the partial dispersion ratio θgF of a certain material are given by the following equations (4) and (5):

νd=(Nd−1)/(NF−NC) (4)

θgF=(Ng−NF)/(NF−NC) (5)

where Nd, NF, NC, and Ng are refractive indices for the d-line, F-line, C-line, and g-line in the Fraunhofer line.

Inequalities (1) to (3) express that the optical element A has high dispersion, low partial dispersion ratio, and high refractive index. A description will now be given of the reason why the optical element A can be used to correct chromatic aberration, especially lateral chromatic aberration.

A longitudinal chromatic aberration coefficient L(λ) and a lateral chromatic aberration coefficient T(λ) at an arbitrary wavelength λ of the optical system are expressed by the following equations (6) and (7), respectively:

L(λ)=Σ(hi²·Φi/vi(λ)) (6)

T(λ)=Σ(hi·Hi·Φi/vi(λ) (7)

Here, hi is a height from the optical axis of a paraxial marginal ray in an i-th lens (where “i” is a natural number) counted from the object side. Hi is a height from the optical axis of a paraxial chief ray in the i-th (where “i” is a natural number) lens counted from the object side. (Di is the refractive power of the i-th lens (where “i” is a natural number) counted from the object side. vi(λ) is a value defined by the following equation (8):

vi (λ)=(ni(λ0)−1)/(ni(λ)−ni(λ0)) (8)

where ni(λ) is the refractive index of the i-th lens counted from the object side (where “i” is a natural number) and λ0 is the design wavelength.

Generally, in a retrofocus type optical system, the longitudinal chromatic aberration coefficient L(λ) and the lateral chromatic aberration coefficient T(λ) exhibit characteristics that the overall slope is negative relative to the wavelength and convex upward. The lateral chromatic aberration is larger than the longitudinal chromatic aberration.

The optical element A is configured such that the lateral chromatic aberration coefficient TA(λ) of the optical element A alone is represented by the following equation (9):

TA(λ)=hA·HA·ΦA/νA(λ) (9)

Here, hA is a height from the optical axis of the paraxial marginal ray in the optical element A. HA is a height from the optical axis of the paraxial chief ray in the optical element A. ΦA is the refractive power of the optical element A. νA(λ) is a value defined by the following equation (10):

νA(λ)=(nA(λ0)−1)/(nA(λ)−nA(λ0)) (10)

where nA(λ) is a refractive index of the optical element A at an arbitrary wavelength λ, and λ0 is the design wavelength.

In order to correct the lateral chromatic aberration in the retrofocus type optical system, the change in the lateral chromatic aberration coefficient TA(λ) against the wavelength and the change in the lateral chromatic aberration coefficient T(λ) against the wavelength may cancel each other out.

In FIG. 13, in a case where the optical element A is disposed on the object side of the intersection P between the optical axis and the paraxial chief ray, the height HA is smaller than 0 and the lateral chromatic aberration coefficient TA(λ) has an entirely positive slope and is convex upward. In a case where the optical element A is disposed on the image side of the intersection P, the height HA is larger than 0, and the lateral chromatic aberration coefficient TA(λ) has an entirely positive slope in a case where the refractive power ΦA is less than 0 and convex upward.

In order to cancel the change in the lateral chromatic aberration coefficient T(λ) against the wavelength by the lateral chromatic aberration coefficient TA(λ), the optical element A is disposed as a positive lens on the object side of the intersection P, or the optical element A is disposed as a negative lens on the image side of the intersection P. In the optical system L0 according to each example, the optical element A disposed on the object side of the intersection P (aperture stop SP) has positive refractive power, and the optical element A disposed on the image side of the intersection P (aperture stop SP) has negative refractive power.

Since the lateral chromatic aberration coefficients T(λ) and TA(λ) both have upwardly convex characteristics, the lateral chromatic aberration remains on the short wavelength side. In a case where the optical element A has negative anomalous partial dispersion, the lateral chromatic aberration coefficient TA(λ) can be moderately dependent on the wavelength on the short wavelength side, thus reducing the remaining lateral chromatic aberration. Therefore, the optical element A has negative anomalous partial dispersion in order to reduce the lateral chromatic aberration over a wider wavelength range. The term “abnormal partial dispersion” refers to a characteristic that the partial dispersion characteristic is different from that of ordinary glass, and the term “negative anomalous partial dispersion” refers to a characteristic that the partial dispersion characteristic on the short wavelength side is smaller than that of ordinary glass.

The conventionally used materials exhibiting high dispersion and negative anomalous partial dispersion tend to have a high refractive index. An attempt to correct the lateral chromatic aberration using these known materials has difficulty in making the Petzval sum of the optical system close to 0, and in correcting the curvature of field. Moreover, the specific gravity of the optical element is large, and the weight of the lens is likely to increase.

Accordingly, the optical system L0 according to each example uses for the optical element A an optical material having a relatively small refractive index while having high dispersion and a low partial dispersion ratio and can satisfactorily correct lateral chromatic aberration and curvature of field.

Inequality (1) defines the refractive index of the optical element A for the d-line. In a case where the refractive index for the d-line of the optical element A becomes higher than the upper limit of inequality (1), the Petzval sum becomes too large in the positive direction, and it becomes difficult to correct the curvature of field. In a case where the refractive index for the d-line of the optical element A becomes lower than the lower limit of inequality (1), the Petzval sum becomes too large in the negative direction and the curvature of field is overcorrected.

Inequality (2) defines the Abbe number of the optical element A. In a case where the Abbe number of the optical element A becomes higher than the upper limit of inequality (2), the dispersion becomes too small and it becomes difficult to correct the primary (first-order) lateral chromatic aberration. In a case where the Abbe number of the optical element A becomes lower than the lower limit of inequality (2), the transmittance of the optical element A tends to decrease and the stability is likely to deteriorate.

Inequality (3) defines the partial dispersion ratio of the optical element A. It is common to use an optical element with a small Abbe number (high dispersion) to perform achromatization of a specific wavelength, but the partial dispersion ratio having an improper value has difficulty in suppressing the secondary spectrum of chromatic aberration. The satisfaction of inequality (3) by the optical element A means that the optical element A has anomalous dispersion. In a case where the anomalous dispersion becomes higher than the upper limit of inequality (3) or lower than the lower limit, it becomes difficult to sufficiently reduce the secondary spectrum of the lateral chromatic aberration.

The above configuration can realize the optical system L0 that can satisfactorily correct various aberrations.

Inequalities (1) to (3) may be replaced with the following inequalities (1a) to (3a):

1.72<Nd<1.84 (1a)

29.0<νd<38.9 (2a)

−0.0090<θgF−(0.64168−0.00162×νd)<−0.0043 (3a)

Inequalities (1) to (3) may be replaced with the following inequalities (1b) to (3b):

1.74<Nd<1.83 (1b)

29.0<νd<38.8 (2b)

−0.0080<θgF−(0.64168−0.00162×νd)<−0.0045 (3b)

A description will now be given of the configuration that may be satisfied in the optical system L0 according to each example.

The optical material constituting the optical element A will be described below. For example, a glass material, which is an example of an optical material, may contain metal oxides. Examples of metal oxides include SiO₂, TiO₂, La₂O₃, Al₂O₃, Nb₂O₅, ZrO₂, and Gd₂O₃. TiO₂, has the effect of increasing the refractive index and decreasing the Abbe number (increasing the dispersion), and a glass material containing a large amount of TiO₂ has a relatively high refractive index and relatively high dispersion. Gd₂O₃ has the effect of increasing the refractive index and increasing the Abbe number (lowering the dispersion), and a glass material containing a large amount of Gd₂O₃ has a relatively high refractive index and relatively low dispersion. Thus, a glass material changes its optical property depending on the components contained therein. This point is similarly applicable to opto-ceramic. For example, including a large amount of a substance with a relatively high refractive index and relatively low dispersion can provide opto-ceramic with a relatively high refractive index and relatively low dispersion. An optical material (such as a glass material, optical ceramic, etc.) including (through melting or sintering), for example, various amounts of inclusions (metal oxides such as SiO₂, TiO₂, La₂O₃, etc.) can provide various optical properties (refractive index, Abbe number, etc.).

The optical element A may be made of a glass material. The glass material is superior to a resin material in having fewer restrictions on workability during manufacturing and can impart strong refractive power. Since the glass material is superior in environmental resistance (high humidity, temperature change, etc.) to the resin material and has sufficient hardness, the optical element A can be disposed closest to the object of the optical system L0.

The optical element A according to each example may be disposed on the image side of the intersection P (aperture stop SP) and have negative refractive power. This configuration can satisfactorily correct the secondary spectrum of the longitudinal chromatic aberration as well as the lateral chromatic aberration.

The optical element A may be provided in the first lens unit disposed closest to the object or the final lens unit disposed closest to the image plane. Thereby, the height from the optical axis of the paraxial chief ray in the optical element A can be increased, and the effect of correcting the lateral chromatic aberration by the optical element A can be further enhanced.

A description will now be given of conditions that the optical system L0 according to each example may satisfy. The optical system L0 according to each example may satisfy one or more of the following inequalities (11) to (14). In a case where the optical system L0 has a plurality of optical elements A, the optical element A having the strongest refractive power may satisfy one or more of inequalities (11) to (14).

0.7<|fA/f|<8.0 (11)

0.2<|dA/fA|<3.0 (12)

0.05<|dA/OVL|<0.70 (13)

1.5<d<4.0 (14)

Here, fA is a focal length of the optical element A. f is a focal length of the optical system L0. In a case where the optical system L0 is a zoom lens, f is a focal length of the optical system L0 at the wide-angle end. dA is a distance on the optical axis from the lens surface on the side of the aperture stop SP of the optical element A to the aperture stop SP. In a case where the optical system L0 is a zoom lens, dA is a distance on the optical axis from the lens surface on the side of the aperture stop SP of the optical element A at the wide-angle end to the aperture stop SP. OVL is a distance (overall lens length) on the optical axis from the lens surface closest to the object of the optical system L0 to the image plane. In a case where the optical system L0 is a zoom lens, OVL is an overall lens length at the wide-angle end. d is the specific gravity of the optical element A.

The optical system L0 according to each example may satisfy the following inequalities (15) or (16). In a case where the optical system L0 includes a plurality of optical elements A, the optical element A having the strongest refractive power may satisfy inequality (15) or (16):

−3.0<(rpa+rpb)/(rpa−rpb)<1.0 (15)

−2.0<(rna+rnb)/(rna−rnb)<2.0 (16)

Here, rpa is a radius of curvature of the lens surface on the object side of the optical element A in a case where the optical element A is disposed on the object side of intersection P and has positive refractive power. rpb is a radius of curvature of the lens surface on the image side of the optical element A in a case where the optical element A is disposed on the object side of intersection P and has positive refractive power. ma is a radius of curvature of the lens surface on the object side of the optical element A in a case where the optical element A is disposed on the image side of intersection P and has negative refractive power. rnb is a radius of curvature of the lens surface on the image side of the optical element A in a case where the optical element A is disposed on the image side of intersection P and has negative refractive power.

Inequality (11) defines a ratio of the focal length of the optical element A and the focal length of the optical system L0. In a case where the ratio becomes higher than the upper limit of inequality (11) and the refractive power of the optical element A becomes too weak, primary chromatic aberration correction tends to be insufficient. In a case where the ratio becomes lower than the lower limit of inequality (11) and the refractive power of the optical element A becomes too strong, it is beneficial to the chromatic aberration correction, but other aberrations (especially chromatic curvature of field) tend to occur.

Inequality (12) defines a ratio of the position of the optical element A and the refractive power of the optical element A. Satisfying inequality (12) enables the secondary spectra of field curvature and lateral chromatic aberration to be effectively corrected. From equation (9), the higher the height from the optical axis of the paraxial chief ray in the optical element A becomes, the greater the lateral chromatic aberration correction effect of the optical element A becomes. In a case where the ratio becomes higher than the upper limit of inequality (12) and the refractive power of the optical element A becomes too weak, correction of primary chromatic aberration tends to be insufficient. In a case where the ratio becomes lower than the lower limit of inequality (12) and the refractive power of the optical element A becomes too strong, which is beneficial to the chromatic aberration correction, other aberrations (especially chromatic curvature of field) tend to occur.

Inequality (13) defines a ratio of the position of the optical element A and the overall lens length. Satisfying inequality (13) enables the secondary spectra of field curvature and lateral chromatic aberration to be effectively corrected. In a case where the optical element A becomes distant from the aperture stop SP and the ratio becomes higher than the upper limit of inequality (13), it is beneficial to the curvature-of-field correction for each wavelength, but the optical system L0 becomes large. In a case where the ratio becomes lower than the lower limit of inequality (13) and the optical element A is disposed closer to the aperture stop SP, proper correction of the lateral chromatic aberration becomes difficult.

Inequality (14) defines the specific gravity of the optical element A. In a case where the specific gravity of the optical element A becomes higher than the upper limit of inequality (14), the lens weight of the optical system L0 increases. In a case where the specific gravity of the optical element A becomes lower than the lower limit of inequality (14), it becomes difficult to form the optical element A from a glass material.

Inequality (15) defines the shape factor of the optical element A in a case where the optical element A is disposed on the object side of intersection P and has positive refractive power. Satisfying inequality (15) enables lateral chromatic aberration and chromatic curvature of field to be effectively corrected. In a case where the value becomes higher than the upper limit of inequality (15), the effect of correcting various aberrations such as lateral chromatic aberration deteriorates. In this case, it becomes particularly difficult to sufficiently correct the secondary spectrum of the lateral chromatic aberration. In a case where the value becomes lower than the lower limit of inequality (15), chromatic curvature of field tends to occur.

Inequality (16) defines the shape factor of the optical element A in a case where the optical element A is disposed on the image side of intersection P and has negative refractive power. Satisfying inequality (16) enables various aberrations such as chromatic aberration, curvature of field, and coma, to be effectively corrected. In a case where the value becomes higher than the upper limit of inequality (16), it becomes difficult to satisfactorily correct various aberrations such as chromatic aberration, curvature of field, and coma. In a case where the value becomes lower than the lower limit of inequality (16), distortion tends to increase.

Inequalities (11) to (16) may be replaced with the following inequalities (11a) to (16a):

0.9<|fA/f|<5.0 (11a)

0.3<|dA/fA|<2.5 (12a)

0.10<|dA/OVL|<0.50 (13a)

2.5<d<3.9 (14a)

−2.4<(rpa+rpb)/(rpa−rpb)<0.0 (15a)

−1.2<(rna+rnb)/(rna−rnb)<1.5 (16a)

Inequalities (11) to (16) may be replaced with the following inequalities (11b) to (16b):

1.1<|fA/f|<4.2 (11b)

0.4<|dA/fA|<2.2 (12b)

0.15<|dA/OVL|<0.42 (13b)

3.0<d<3.8 (14b)

−1.8<(rpa+rpb)/(rpa−rpb)<−0.1 (15b)

−0.9<(rna+rnb)/(rna−rnb)<1.2 (16b)

A detailed description will be given of the optical system L0 according to each example.

The optical system L0 according to Example 1 is a fixed focal length lens including, in order from the object side to the image side, a first lens unit L1 having positive refractive power and a second lens unit L2 having positive refractive power.

Each of the optical systems L0 according to Examples 2 to 4 includes, in order from the object side to the image side, a first lens unit L1 having negative refractive power and a second lens unit L2 having positive refractive power. A distance between the first lens unit L1 and the second lens unit L2 is reduced during zooming from the wide-angle end to the telephoto end. Properly placing the optical element A in such a lens configuration can reduce fluctuations in the lateral chromatic aberration during zooming.

Each of the optical systems L0 according to Examples 5 and 6 includes, in order from the object side to the image side, a first lens unit L1 having positive refractive power and a second lens unit L2 having negative refractive power. A distance between the first lens unit L1 and the second lens unit L2 is increased during zooming from the wide-angle end to the telephoto end. Properly placing the optical element A in such a lens configuration can reduce fluctuations in the lateral chromatic aberration during zooming.

Numerical examples 1 to 6 corresponding to Examples 1 to 6, respectively, will be illustrated below.

In surface data in each numerical example, r represents a radius of curvature of each optical surface, and d (mm) represents an on-axis distance (distance on the optical axis) between an m-th surface and a (m+1)-th surface, where m is a surface number counted from the light incident side. nd represents a refractive index of each optical member for the d-line, νd represents an Abbe number of each optical member, and θgF represents a partial dispersion ratio for the g-line and F-line of each optical member.

In each numerical example, values of d, focal length (mm), F-number, and a half angle of view (degrees) are set in a case where the optical system L0 according to each example is in an in-focus state on an infinite object. “Back focus” (BK) represents a distance on the optical axis from the final lens surface (lens surface closest to the image plane) to the paraxial image plane expressed in air conversion length. An “overall lens length” is a length obtained by adding the back focus to the distance on the optical axis from the foremost front surface (lens surface closest to the object) of the optical system L0 to the final surface.

In a case where the optical surface is an aspherical surface, an asterisk * is attached to the right side of the surface number. The aspherical shape is expressed as follows:

x=(h²/R)/[1+{1−(1+k)(h/R)²}^{1/2}]+A4×h⁴+A6×h⁶+A8×h⁸+A10×h¹⁰

+A12×h¹²+A14×h¹⁴+A16×h¹⁶

where X is a displacement amount from a surface vertex in the optical axis direction, h is a height from the optical axis in a direction orthogonal to the optical axis, a light traveling direction is set positive, R is a paraxial radius of curvature, K is a conic constant, A4, A6, A8, A10, A12, A14, and A16 are aspherical coefficients of respective orders. “e±XX” in the conic constant means “×10±XX.”

### NUMERICAL EXAMPLE 1

UNIT: mm
SURFACE DATA

| Surface No. | r | d | nd | νd | θgF |
|---|---|---|---|---|---|
| 1 | 44.045 | 3.60 | 1.77250 | 49.6 | 0.5520 |
| 2 | 26.495 | 5.32 | | | |
| 3 | 29.729 | 3.10 | 1.77250 | 49.6 | 0.5520 |
| 4 | 20.032 | 6.06 | | | |
| 5 | 24.259 | 3.35 | 1.58313 | 59.4 | 0.5423 |
| 6* | 11.250 | 10.32 | | | |
| 7 | 83.413 | 2.24 | 1.80400 | 46.6 | 0.5572 |
| 8 | 21.634 | 5.93 | | | |
| 9 | 45.052 | 4.83 | 1.78000 | 35.0 | 0.5789 |
| 10 | −5375.026 | 0.15 | | | |
| 11 | 31.679 | 1.80 | 1.80400 | 46.6 | 0.5572 |
| 12 | 19.624 | 6.86 | 1.74951 | 35.3 | 0.5818 |
| 13 | −83.833 | (Variable) | | | |
| 14 | −223.875 | 1.30 | 1.80400 | 46.6 | 0.5572 |
| 15 | 20.997 | 9.34 | 1.51633 | 64.1 | 0.5353 |
| 16 | −26.019 | 1.16 | | | |
| 17 | ∞ | 3.49 | | | |
| (Aperture Stop) | | | | | |
| 18 | −37.556 | 1.20 | 1.80400 | 46.6 | 0.5572 |
| 19 | 220.268 | 0.20 | | | |
| 20 | 34.968 | 6.45 | 1.49700 | 81.5 | 0.5375 |
| 21 | −10.271 | 1.30 | 1.83481 | 42.7 | 0.5642 |
| 22 | −864.344 | 0.20 | | | |
| 23 | 67.333 | 6.76 | 1.49700 | 81.5 | 0.5375 |
| 24 | −14.636 | 0.20 | | | |
| 25* | −99.187 | 4.21 | 1.58313 | 59.4 | 0.5423 |
| 26 | −31.610 | (Variable) | | | |
| 27 | ∞ | 2.00 | 1.51633 | 64.1 | 0.5353 |
| 28 | ∞ | (Variable) | | | |
| Image Plane | ∞ | | | | |

ASPHERIC DATA
6th Surface
K = −6.72663e−01 A4 = −9.06368e−06 A6 = −7.35030e−08 A8 = 1.56151e−10
A10 = −1.58584e−12 A12 = 0.00000e−00 A14 = 0.00000e−00 A16 = 0.00000e−00
25th Surface
K = 0.00000e+00 A4 = −2.68589e−05 A6 = −3.11179e−08 A8 = −1.25703e−10
A10 = −1.46936e−12 A12 = 0.00000e−00 A14 = 0.00000e−00 A16 = 0.00000e−00
VARIOUS DATA

| | |
|---|---|
| Focal Length | 14.16 |
| FNo | 2.89 |
| Half Angle of View (Degree) | 56.79 |
| Image Height | 21.64 |
| Overall Lens Length (in air) | 131.64 |
| BF (in air) | 38.99 |

| Object Distance | Infinity | 0.2 m |
|---|---|---|
| d13 | 3.27 | 1.00 |
| d26 | 36.68 | 38.94 |
| d28 | 1.00 | 1.00 |

LENS UNIT DATA

| Lens Unit | Starting Surface | Focal Length |
|---|---|---|
| 1 | 1 | 55.24 |
| 2 | 14 | 36.67 |
| 3 | 27 | ∞ |

### NUMERICAL EXAMPLE 2

UNIT: mm
SURFACE DATA

| Surface No. | r | d | nd | νd | θgF |
|---|---|---|---|---|---|
| 1* | 642.421 | 2.30 | 1.76385 | 48.5 | 0.5587 |
| 2 | 21.748 | 7.91 | | | |
| 3 | 59.205 | 2.00 | 1.80400 | 46.6 | 0.5572 |
| 4* | 33.036 | 7.14 | | | |
| 5 | −161.373 | 1.60 | 1.83400 | 37.2 | 0.5776 |
| 6 | 78.311 | 0.15 | | | |
| 7 | 43.270 | 4.99 | 1.80518 | 25.4 | 0.6161 |
| 8 | −7748.422 | (Variable) | | | |
| 9 | 58.578 | 1.30 | 1.80518 | 25.4 | 0.6161 |
| 10 | 24.859 | 4.60 | 1.54072 | 47.2 | 0.5651 |
| 11 | 764.547 | 0.15 | | | |
| 12 | 98.441 | 2.71 | 1.80400 | 46.6 | 0.5572 |
| 13 | −243.247 | 5.02 | | | |
| 14 | 60.392 | 3.91 | 1.62299 | 58.2 | 0.5458 |
| 15 | −74.158 | (Variable) | | | |
| 16 | ∞ | 2.05 | | | |
| (Aperture Stop) | | | | | |
| 17 | −586.110 | 1.40 | 1.88300 | 40.8 | 0.5667 |
| 18 | 83.783 | 2.58 | | | |
| 19 | −34.929 | 1.10 | 1.76200 | 40.1 | 0.5765 |
| 20 | 23.941 | 5.74 | 1.84666 | 23.8 | 0.6191 |
| 21 | −98.602 | 0.20 | | | |
| 22 | ∞ | (Variable) | | | |
| 23 | 34.486 | 8.62 | 1.49700 | 81.5 | 0.5375 |
| 24 | −21.497 | 1.20 | 1.84666 | 23.8 | 0.6205 |
| 25 | −33.759 | 0.20 | | | |
| 26 | 271.932 | 1.20 | 1.75000 | 38.7 | 0.5739 |
| 27 | 20.143 | 6.98 | 1.49700 | 81.5 | 0.5375 |
| 28 | −97.789 | 0.20 | | | |
| 29 | 218.610 | 2.90 | 1.58313 | 59.4 | 0.5423 |
| 30* | −241.453 | (Variable) | | | |
| 31 | ∞ | (Variable) | | | |
| 32 | ∞ | 2.00 | 1.51633 | 64.1 | 0.5353 |
| 33 | ∞ | (Variable) | | | |
| Image Plane | ∞ | | | | |

ASPHERIC DATA
1st Surface
K = 0.00000e+00 A4 = 1.64116e−05 A6 = −2.66147e−08 A8 = 3.44248e−11
A10 = −2.77570e−14 A12 = 9.67635e−18 A14 = 0.00000e−00 A16 = 0.00000e−00
4th Surface
K = 0.00000e+00 A4 = 9.32254e−06 A6 = 5.34468e−09 A8 = −9.66724e−11
A10 = 2.05360e−13 A12 = −2.51932e−16 A14 = 0.00000e−00 A16 = 0.00000e−00
30th Surface
K = 0.00000e+00 A4 = 7.93766e−06 A6 = 1.06911e−08 A8 = −9.86904e−12
A10 = −7.47391e−15 A12 = 0.00000e−00 A14 = 0.00000e−00 A16 = 0.00000e−00
VARIOUS DATA
Zoom Ratio 2.06

| | Wide | Middle | Telephoto |
|---|---|---|---|
| Focal Length | 16.48 | 24.00 | 33.95 |
| FNo | 2.91 | 2.91 | 2.91 |
| Half Angle of View (Degree) | 52.69 | 42.03 | 32.51 |
| Image Height | 21.64 | 21.64 | 21.64 |
| Overall Lens Length (in air) | 153.93 | 145.98 | 147.43 |
| BF (in air) | 37.84 | 46.13 | 56.90 |
| d8 | 26.55 | 10.31 | 1.00 |
| d15 | 1.07 | 5.47 | 10.82 |
| d22 | 10.30 | 5.90 | 0.56 |
| d30 | 0.49 | 8.77 | 19.54 |
| d31 | 35.04 | 35.04 | 35.04 |
| d33 | 1.00 | 1.00 | 1.00 |

ZOOM LENS UNIT DATA

| Lens Unit | Starting Surface | Focal Length |
|---|---|---|
| 1 | 1 | −23.46 |
| 2 | 9 | 33.33 |
| 3 | 16 | −47.67 |
| 4 | 23 | 45.22 |
| 5 | 31 | ∞ |
| 6 | 32 | ∞ |

### NUMERICAL EXAMPLE 3

UNIT: mm
SURFACE DATA

| Surface No. | r | d | nd | νd | θgF |
|---|---|---|---|---|---|
| 1* | 1815.945 | 2.80 | 1.76385 | 48.5 | 0.5587 |
| 2* | 19.598 | 9.96 | | | |
| 3* | 858.217 | 2.50 | 1.85135 | 40.1 | 0.5695 |
| 4* | 79.552 | 8.11 | | | |
| 5 | −36.988 | 1.40 | 1.53775 | 74.7 | 0.5392 |
| 6 | 195.746 | 0.15 | | | |
| 7 | 66.449 | 5.08 | 1.82000 | 30.0 | 0.5889 |
| 8 | −123.035 | (Variable) | | | |
| 9 | ∞ | 1.96 | | | |
| 10 | 93.181 | 2.82 | 1.85026 | 32.3 | 0.5929 |
| 11 | −194.367 | 0.15 | | | |
| 12 | 51.278 | 1.25 | 1.84666 | 23.8 | 0.6205 |
| 13 | 23.088 | 6.16 | 1.57501 | 41.5 | 0.5767 |
| 14 | 233.756 | (Variable) | | | |
| 15 | 59.025 | 1.25 | 1.84666 | 23.8 | 0.6205 |
| 16 | 38.449 | 6.34 | 1.51633 | 64.1 | 0.5353 |
| 17 | −55.502 | (Variable) | | | |
| 18 | ∞ | 1.82 | | | |
| (Aperture Stop) | | | | | |
| 19 | −56.356 | 1.00 | 1.90525 | 35.0 | 0.5848 |
| 20 | 83.856 | 3.27 | | | |
| 21 | 42.485 | 6.32 | 1.80810 | 22.8 | 0.6307 |
| 22 | −31.903 | 1.10 | 1.91082 | 35.2 | 0.5824 |
| 23 | 79.455 | 2.87 | | | |
| 24 | ∞ | (Variable) | | | |
| 25 | 32.281 | 9.13 | 1.49700 | 81.5 | 0.5375 |
| 26 | −20.823 | 1.20 | 1.83481 | 42.7 | 0.5648 |
| 27 | −28.699 | 0.15 | | | |
| 28* | 121.423 | 1.27 | 1.90366 | 31.3 | 0.5963 |
| 29 | 24.708 | 6.21 | 1.49700 | 81.5 | 0.5375 |
| 30 | −126.479 | (Variable) | | | |
| 31 | ∞ | (Variable) | | | |
| 32 | ∞ | 2.00 | 1.51633 | 64.1 | 0.5353 |
| 33 | ∞ | (Variable) | | | |
| Image Plane | ∞ | | | | |

ASPHERIC DATA
1st Surface
K = 0.00000e+00 A4 = 1.14386e−05 A6 = −1.37546e−08 A8 = 1.49739e−11
A10 = −1.14988e−14 A12 = 2.36155e−17 A14 = −3.46263e−20 A16 = 1.96897e−23
2nd Surface
K = −1.28966e+00 A4 = −3.90381e−06 A6 = −6.19613e−10 A8 = 2.87866e−11
A10 = −7.05339e−13 A12 = 1.58925e−15 A14 = 6.20074e−20 A16 = −1.71485e−21
3rd Surface
K = 0.00000e+00 A4 = −3.75358e−05 A6 = 1.10624e−07 A8 = −1.09528e−10
A10 = 3.20215e−14 A12 = 2.37132e−16 A14 = −1.12443e−18 A16 = 1.26047e−21
4th Surface
K = 8.77138e+00 A4 = −1.68844e−05 A6 = 1.38254e−07 A8 = −6.74837e−11
A10 = 1.37893e−13 A12 = 2.42975e−16 A14 = 2.08380e−18 A16 = −8.62893e−21
28th Surface
K = 0.00000e+00 A4 = −9.29621e−06 A6 = 1.42551e−08 A8 = −3.37301e−10
A10 = 2.54004e−12 A12 = −9.90827e−15 A14 = 1.47087e−17 A16 = 4.20423e−21
VARIOUS DATA
Zoom Ratio 2.06

| | Wide | Middle | Telephoto |
|---|---|---|---|
| Focal Length | 16.48 | 24.11 | 33.95 |
| FNo | 2.94 | 2.95 | 2.93 |
| Half Angle of View (Degree) | 52.70 | 41.90 | 32.51 |
| Image Height | 21.64 | 21.64 | 21.64 |
| Overall Lens Length (in air) | 168.02 | 164.03 | 166.09 |
| BF (in air) | 39.77 | 49.57 | 64.19 |
| d8 | 27.26 | 11.09 | 1.39 |
| d14 | 4.52 | 9.08 | 4.60 |
| d17 | 2.40 | 7.54 | 11.97 |
| d24 | 9.81 | 2.48 | −0.32 |
| d30 | 1.57 | 11.37 | 25.99 |
| d31 | 35.88 | 35.88 | 35.88 |
| d33 | 1.00 | 1.00 | 1.00 |

ZOOM LENS UNIT DATA

| Lens Unit | Starting Surface | Focal Length |
|---|---|---|
| 1 | 1 | −21.39 |
| 2 | 9 | 61.92 |
| 3 | 15 | 67.47 |
| 4 | 18 | −44.31 |
| 5 | 25 | 44.60 |
| 6 | 31 | ∞ |
| 7 | 32 | ∞ |

### NUMERICAL EXAMPLE 4

UNIT: mm
SURFACE DATA

| Surface No. | r | d | nd | νd | θgF |
|---|---|---|---|---|---|
| 1* | −2309.530 | 3.00 | 1.58313 | 59.4 | 0.5423 |
| 2* | 17.415 | 9.44 | | | |
| 3* | 619.727 | 2.25 | 1.85400 | 40.4 | 0.5688 |
| 4* | 57.748 | 6.24 | | | |
| 5 | −46.612 | 1.20 | 1.59522 | 67.7 | 0.5442 |
| 6 | 123.990 | 0.15 | | | |
| 7 | 48.647 | 4.11 | 1.84666 | 23.9 | 0.6205 |
| 8 | −449.695 | (Variable) | | | |
| 9 | 64.186 | 3.06 | 1.85478 | 24.8 | 0.6122 |
| 10 | −262.042 | 0.15 | | | |
| 11 | 46.126 | 1.20 | 1.92286 | 20.9 | 0.6391 |
| 12 | 21.668 | 4.56 | 1.53172 | 48.8 | 0.5631 |
| 13 | 129.577 | (Variable) | | | |
| 14 | ∞ | (Variable) | | | |
| (Aperture Stop) | | | | | |
| 15 | 28.910 | 1.50 | 2.00069 | 25.5 | 0.6136 |
| 16 | 20.171 | 8.20 | 1.53775 | 74.7 | 0.5392 |
| 17 | −72.892 | (Variable) | | | |
| 18 | −58.497 | 3.76 | 1.92286 | 20.9 | 0.6391 |
| 19 | −21.480 | 0.90 | 1.83400 | 37.2 | 0.5776 |
| 20 | 138.529 | 1.24 | | | |
| 21 | ∞ | (Variable) | | | |
| 22 | 31.724 | 12.07 | 1.43700 | 95.1 | 0.5326 |
| 23 | −44.374 | 0.22 | | | |
| 24 | 36.141 | 11.85 | 1.43700 | 95.1 | 0.5326 |
| 25 | −27.421 | 1.25 | 1.82000 | 30.0 | 0.5889 |
| 26 | 264.944 | 4.92 | | | |
| 27* | −159.555 | 2.00 | 1.85400 | 40.4 | 0.5688 |
| 28* | 549.181 | 0.15 | | | |
| 29 | 113.696 | 3.04 | 1.92286 | 20.9 | 0.6391 |
| 30 | 666.393 | (Variable) | | | |
| 31 | ∞ | 2.00 | 1.51633 | 64.1 | 0.5353 |
| 32 | ∞ | (Variable) | | | |
| Image Plane | ∞ | | | | |

ASPHERIC DATA
1st Surface
K = 0.00000e+00 A4 = 7.69206e−06 A6 = −6.57480e−09 A8 = 2.24547e−11
A10 = −4.01815e−14 A12 = 3.47125e−17 A14 = −1.11737e−20 A16 = 0.00000e−00
2nd Surface
K = −1.00861e+00 A4 = −5.05508e−06 A6 = −2.84968e−08 A8 = −1.08950e−10
A10 = 7.86240e−13 A12 = −2.55999e−15 A14 = 2.77613e−18 A16 = 0.00000e−00
3rd Surface
K = 0.00000e+00 A4 = −9.71485e−06 A6 = −1.52719e−07 A8 = 1.22287e−09
A10 = −3.60037e−12 A12 = 4.60402e−15 A14 = −1.97371e−18 A16 = 0.00000e−00
4th Surface
K = 0.00000e+00 A4 = 9.21260e−06 A6 = −1.30409e−07 A8 = 1.68537e−09
A10 = −6.55695e−12 A12 = 1.51327e−14 A14 = −1.58122e−17 A16 = 0.00000e−00
27th Surface
K = 0.00000e+00 A4 = −9.37341e−05 A6 = 2.52318e−07 A8 = −9.55812e−10
A10 = 3.49669e−12 A12 = −2.00316e−15 A14 = −1.00673e−17 A16 = 0.00000e−00
28th Surface
K = 0.00000e+00 A4 = −7.66437e−05 A6 = 2.74989e−07 A8 = −8.21599e−10
A10 = 2.78279e−12 A12 = −4.40211e−15 A14 = 1.04024e−18 A16 = 0.00000e−00
VARIOUS DATA
Zoom Ratio 2.20

| | Wide | Middle | Telephoto |
|---|---|---|---|
| Focal Length | 15.45 | 24.01 | 33.93 |
| FNo | 2.91 | 2.91 | 2.91 |
| Half Angle of View (Degree) | 54.47 | 42.02 | 32.53 |
| Image Height | 21.64 | 21.64 | 21.64 |
| Overall Lens Length (in air) | 156.21 | 145.88 | 143.88 |
| BF (in air) | 14.34 | 22.45 | 33.10 |
| d8 | 22.72 | 6.58 | 1.00 |
| d13 | 8.92 | 12.40 | 7.25 |
| d14 | 14.17 | 4.95 | 0.72 |
| d17 | 1.79 | 11.00 | 15.23 |
| d21 | 7.81 | 2.02 | 0.10 |
| d30 | 12.00 | 20.11 | 30.76 |
| d32 | 1.03 | 1.03 | 1.03 |

ZOOM LENS UNIT DATA

| Lens Unit | Starting Surface | Focal Length |
|---|---|---|
| 1 | 1 | −20.89 |
| 2 | 9 | 66.05 |
| 3 | 14 | ∞ |
| 4 | 15 | 52.74 |
| 5 | 18 | −56.33 |
| 6 | 22 | 44.14 |
| 7 | 31 | ∞ |

### NUMERICAL EXAMPLE 5

UNIT: mm
SURFACE DATA

| Surface No. | r | d | nd | νd | θgF |
|---|---|---|---|---|---|
| 1 | 145.308 | 2.50 | 1.83400 | 37.2 | 0.5776 |
| 2 | 73.624 | 12.53 | 1.49700 | 81.5 | 0.5375 |
| 3 | −815.720 | 0.15 | | | |
| 4 | 66.900 | 8.89 | 1.49700 | 81.5 | 0.5375 |
| 5 | 370.696 | (Variable) | | | |
| 6* | 231.440 | 1.50 | 1.88300 | 40.8 | 0.5667 |
| 7 | 20.094 | 7.22 | | | |
| 8 | −33.709 | 1.20 | 1.88300 | 40.8 | 0.5667 |
| 9 | 30.986 | 3.08 | 1.82000 | 30.0 | 0.5889 |
| 10 | 124.419 | 0.15 | | | |
| 11 | 62.113 | 4.46 | 1.80518 | 25.4 | 0.6161 |
| 12 | −32.168 | 1.08 | | | |
| 13 | −22.983 | 1.30 | 1.77250 | 49.6 | 0.5520 |
| 14 | −51.138 | (Variable) | | | |
| 15 | ∞ | 0.20 | | | |
| (Aperture Stop) | | | | | |
| 16 | 63.632 | 3.39 | 1.51823 | 58.9 | 0.5457 |
| 17 | 132.051 | (Variable) | | | |
| 18 | 39.248 | 7.79 | 1.48749 | 70.2 | 0.5300 |
| 19 | −46.004 | 1.80 | 1.84666 | 23.8 | 0.6205 |
| 20 | −67.984 | 0.15 | | | |
| 21 | 44.874 | 1.80 | 1.80518 | 25.4 | 0.6161 |
| 22 | 25.620 | 0.55 | | | |
| 23 | 28.853 | 6.48 | 1.58313 | 59.4 | 0.5423 |
| 24* | −95.009 | (Variable) | | | |
| 25 | −85.043 | 1.35 | 1.83481 | 42.7 | 0.5642 |
| 26 | 62.190 | 2.25 | | | |
| 27 | −52.288 | 1.20 | 1.61800 | 63.3 | 0.5441 |
| 28 | 39.309 | 5.50 | 1.68948 | 31.0 | 0.5987 |
| 29* | −60.895 | (Variable) | | | |
| 30 | 32.122 | 9.93 | 1.49700 | 81.5 | 0.5375 |
| 31 | −45.285 | 2.50 | 1.77250 | 49.6 | 0.5520 |
| 32 | −67.551 | 3.43 | | | |
| 33 | −204.985 | 2.50 | 1.83481 | 42.7 | 0.5642 |
| 34 | 29.898 | 7.70 | 1.51742 | 52.4 | 0.5564 |
| 35 | −226.816 | 2.42 | | | |
| 36 | 50.317 | 2.70 | 1.67790 | 55.3 | 0.5472 |
| 37 | 30.856 | 7.68 | 1.48749 | 70.2 | 0.5300 |
| 38 | −76.120 | 4.33 | | | |
| 39 | −25.704 | 2.50 | 1.80400 | 46.6 | 0.5572 |
| 40 | −47.895 | (Variable) | | | |
| 41 | ∞ | 2.00 | 1.51633 | 64.1 | 0.5353 |
| 42 | ∞ | (Variable) | | | |
| Image Plane | ∞ | | | | |

ASPHERIC DATA
6th Surface
K = 0.00000e+00 A4 = 5.53906e−06 A6 = −3.58885e−09 A8 = 8.08466e−13
A10 = 3.89246e−14 A12 = 0.00000e−00 A14 = 0.00000e−00 A16 = 0.00000e−00
24th Surface
K = 0.00000e+00 A4 = 6.08226e−06 A6 = −1.70454e−10 A8 = −1.65332e−12
A10 = 1.35017e−14 A12 = 0.00000e−00 A14 = 0.00000e−00 A16 = 0.00000e−00
29th Surface
K = 0.00000e+00 A4 = −1.18719e−06 A6 = −2.36714e−09 A8 = 1.71541e−11
A10 = −5.50097e−14 A12 = 0.00000e−00 A14 = 0.00000e−00 A16 = 0.00000e−00
VARIOUS DATA
Zoom Ratio 10.08

| | Wide | Middle | Telephoto |
|---|---|---|---|
| Focal Length | 28.80 | 99.72 | 290.34 |
| FNo | 3.63 | 5.18 | 5.88 |
| Half Angle of View (Degree) | 36.92 | 12.24 | 4.26 |
| Image Height | 21.64 | 21.64 | 21.64 |
| Overall Lens Length (in air) | 224.59 | 264.17 | 297.22 |
| BF (in air) | 38.76 | 70.80 | 83.31 |
| d5 | 4.29 | 43.14 | 73.04 |
| d14 | 33.04 | 12.75 | 1.19 |
| d17 | 5.23 | 1.92 | 1.39 |
| d24 | 1.00 | 8.39 | 15.21 |
| d29 | 20.05 | 4.95 | 0.87 |
| d40 | 36.44 | 68.48 | 81.00 |
| d42 | 1.00 | 1.00 | 1.00 |

ZOOM LENS UNIT DATA

| Lens Unit | Starting Surface | Focal Length |
|---|---|---|
| 1 | 1 | 127.44 |
| 2 | 6 | −17.92 |
| 3 | 15 | 233.04 |
| 4 | 18 | 35.53 |
| 5 | 25 | −49.17 |
| 6 | 30 | 84.78 |
| 7 | 41 | ∞ |

### NUMERICAL EXAMPLE 6

UNIT: mm
SURFACE DATA

| Surface No. | r | d | nd | νd | θgF |
|---|---|---|---|---|---|
| 1 | 190.511 | 2.00 | 1.84666 | 23.9 | 0.6199 |
| 2 | 69.133 | 9.66 | 1.60311 | 60.6 | 0.5415 |
| 3 | −1150.767 | 0.15 | | | |
| 4 | 48.982 | 8.31 | 1.71300 | 53.9 | 0.5459 |
| 5 | 122.313 | (Variable) | | | |
| 6* | 73.492 | 1.50 | 1.80400 | 46.6 | 0.5572 |
| 7 | 12.191 | 6.65 | | | |
| 8 | −36.243 | 1.00 | 1.83481 | 42.7 | 0.5642 |
| 9 | 36.108 | 0.15 | | | |
| 10 | 26.905 | 4.12 | 1.78000 | 35.0 | 0.5789 |
| 11 | −36.131 | 0.68 | | | |
| 12 | −24.088 | 0.90 | 1.77250 | 49.6 | 0.5520 |
| 13 | 47.257 | 3.87 | 1.80810 | 22.8 | 0.6307 |
| 14 | −106.940 | (Variable) | | | |
| 15 | ∞ | 0.29 | | | |
| 16 | 173.630 | 2.80 | 1.58913 | 61.1 | 0.5407 |
| 17 | −40.812 | 2.23 | | | |
| 18 | ∞ | 2.56 | | | |
| (Aperture Stop) | | | | | |
| 19* | 37.002 | 8.08 | 1.58313 | 59.4 | 0.5423 |
| 20 | −17.542 | 1.50 | 1.84666 | 23.8 | 0.6205 |
| 21 | −27.613 | (Variable) | | | |
| 22 | −50.889 | 2.60 | 1.84666 | 23.8 | 0.6205 |
| 23 | −18.243 | 0.80 | 1.69680 | 55.5 | 0.5434 |
| 24 | 74.306 | 3.70 | | | |
| 25 | −27.167 | 1.00 | 1.84666 | 23.8 | 0.6205 |
| 26 | −153.579 | 2.68 | 1.58913 | 61.1 | 0.5407 |
| 27 | −38.507 | (Variable) | | | |
| 28* | 184.187 | 1.50 | 1.80400 | 46.6 | 0.5572 |
| 29 | 43.542 | 6.44 | 1.49700 | 81.5 | 0.5375 |
| 30 | −32.645 | 0.25 | | | |
| 31 | 59.857 | 8.58 | 1.49700 | 81.5 | 0.5375 |
| 32 | −21.517 | 1.50 | 1.74951 | 35.3 | 0.5818 |
| 33 | −39.537 | (Variable) | | | |
| 34 | ∞ | 2.00 | 1.51633 | 64.1 | 0.5353 |
| 35 | ∞ | (Variable) | | | |
| Image Plane | ∞ | | | | |

ASPHERIC DATA
6th Surface
K = 0.00000e+00 A4 = 1.03397e−05 A6 = −2.87988e−08 A8 = 5.60771e−11
A10 = −8.11128e−14 A12 = 0.00000e−00 A14 = 0.00000e−00 A16 = 0.00000e−00
19th Surface
K = 0.00000e+00 A4 = −8.14651e−06 A6 = −1.46591e−08 A8 = 8.95059e−11
A10 = −3.73169e−13 A12 = 0.00000e−00 A14 = 0.00000e−00 A16 = 0.00000e−00
28th Surface
K = 0.00000e+00 A4 = −3.49307e−06 A6 = 9.87989e−09 A8 = −9.93973e−12
A10 = 3.28005e−14 A12 = 0.00000e−00 A14 = 0.00000e−00 A16 = 0.00000e−00
VARIOUS DATA
Zoom Ratio 3.05

| | Wide | Middle | Telephoto |
|---|---|---|---|
| Focal Length | 17.56 | 34.75 | 53.49 |
| FNo | 2.91 | 2.91 | 2.92 |
| Half Angle of View (Degree) | 37.89 | 21.46 | 14.33 |
| Image Height | 13.66 | 13.66 | 13.66 |
| Overall Lens Length (in air) | 152.26 | 166.45 | 179.13 |
| BF (in air) | 35.33 | 41.94 | 48.10 |
| d 5 | 3.94 | 21.54 | 32.32 |
| d14 | 15.28 | 5.25 | 1.00 |
| d21 | 1.99 | 7.75 | 10.26 |
| d27 | 10.22 | 4.46 | 1.94 |
| d33 | 33.01 | 39.63 | 45.78 |
| d35 | 1.00 | 1.00 | 1.00 |

ZOOM LENS UNIT DATA

| Lens Unit | Starting Surface | Focal Length |
|---|---|---|
| 1 | 1 | 94.88 |
| 2 | 6 | −12.64 |
| 3 | 15 | 23.15 |
| 4 | 22 | −31.64 |
| 5 | 28 | 36.71 |
| 6 | 34 | ∞ |

TABLE 1 below summarizes various values in each numerical example. Each parenthesis represents a corresponding inequality.

TABLE 1

| | Example | Example | Example | Example | Example | Example |
|---|---|---|---|---|---|---|
| | 1 | 2 | 3 | 4 | 5 | 6 |
| Nd | 1.78 | 1.75 | 1.82 | 1.82 | 1.82 | 1.78 |
| νd | 35 | 38.7 | 30 | 30 | 30 | 35 |
| θgF | 0.5789 | 0.5739 | 0.5889 | 0.5889 | 0.5889 | 0.5789 |
| fA | 57.302 | −29.065 | 53.261 | −30.246 | 49.584 | 20.354 |
| f | 14.160 | 16.485 | 16.479 | 15.451 | 28.799 | 17.556 |
| rpa | 45.052 | — | 66.449 | — | 30.986 | 26.905 |
| rpb | −5375.026 | — | −123.035 | — | 124.419 | −36.131 |
| rna | — | 271.932 | — | −27.421 | — | — |
| rnb | — | 20.143 | — | 264.944 | — | — |
| dA | 23.882 | 33.398 | 54.108 | 63.501 | 40.035 | 26.054 |
| OVL | 131.642 | 153.934 | 168.020 | 156.215 | 224.591 | 152.263 |
| d | 3.47 | 3.47 | 3.47 | 3.47 | 3.47 | 3.47 |
| (1) | 1.780 | 1.750 | 1.820 | 1.820 | 1.820 | 1.780 |
| (2) | 35.0 | 38.7 | 30.0 | 30.0 | 30.0 | 35.0 |
| (3) | −0.0061 | −0.0051 | −0.0042 | −0.0042 | −0.0042 | −0.0061 |
| (11) | 4.047 | 1.763 | 3.232 | 1.958 | 1.722 | 1.159 |
| (12) | −0.983 | — | −0.299 | — | −1.663 | −0.146 |
| (13) | — | 1.160 | — | −0.812 | — | — |
| (14) | 0.417 | 1.149 | 1.016 | 2.100 | 0.807 | 1.280 |
| (15) | 0.181 | 0.217 | 0.322 | 0.407 | 0.178 | 0.171 |
| (16) | 3.47 | 3.47 | 3.47 | 3.47 | 3.47 | 3.47 |

### IMAGE PICKUP APPARATUS

Referring now to FIG. 14, a description will now be given of a digital still camera (image pickup apparatus) using the optical system L0 according to each example as an imaging optical system. In FIG. 14, reference numeral 10 denotes a camera body, and reference numeral 11 denotes an imaging optical system including one of the optical systems L0 according to Examples 1 to 6. Reference numeral 12 denotes a solid-state image sensor (photoelectric conversion element) such as a CCD or CMOS sensor, which is built in the camera body 10 and receives and photoelectrically converts an optical image formed by the imaging optical system 11. The camera body 10 may be a so-called single-lens reflex camera having a quick turn mirror, or a so-called mirrorless camera without a quick turn mirror.

Applying the optical system L0 according to each example to an image pickup apparatus such as a digital still camera can provide a compact and high optical performance image pickup apparatus in which the secondary spectrum of the lateral chromatic aberration is satisfactorily corrected.

This embodiment can provide an optical system that can satisfactorily correct various aberrations.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-110998, filed on Jul. 11, 2022, which is hereby incorporated by reference herein in its entirety.

What is claimed is:

1. An optical system, in which a height from an optical axis of a paraxial marginal ray that passes through a lens surface closest to an object is smaller than a maximum height from the optical axis of the paraxial marginal ray that passes through a lens surface on an image side of an intersection between the optical axis and a paraxial chief ray, the optical system comprising an optical element disposed on an object side or the image side of the intersection,
wherein the optical element has positive refractive power in a case where the optical element is disposed on the object side of the intersection, and has negative refractive power in a case where the optical element is disposed placed on the image side of the intersection, and
wherein the following inequalities are satisfied:
1.70<Nd<1.85
28<νd<39
−0.010<θgF−(0.64168−0.00162×νd)<−0.004
where Nd is a refractive index for d-line of the optical element, νd is an Abbe number of the optical element, and θgF is a partial dispersion ratio for g-line and F-line of the optical element.

2. The optical system according to claim 1, wherein the optical element is made of a glass material.

3. The optical system according to claim 1, wherein the following inequality is satisfied:
0.7<|fA/f|<8.0
where f is a focal length of the optical system, and fA is a focal length of the optical element.

4. The optical system according to claim 1, wherein in the case where the optical element is disposed on the object side of the intersection, the following inequality is satisfied:
−3.0<(rpa+rpb)/(rpa−rpb)<1.0
where rpa is a radius of curvature of the lens surface on the object side of the optical element, and rpb is a radius of curvature of the lens surface on the image side of the optical element.

5. The optical system according to claim 1, wherein in the case where the optical element is disposed on the image side of the intersection, the following inequality is satisfied:
−2.0<(rna+rnb)/(rna−rnb)<2.0
where ma is a radius of curvature of the lens surface on the object side of the optical element, and mb is a radius of curvature of the lens surface on the image side of the optical element.

6. The optical system according to claim 1, further comprising an aperture stop,
wherein the following inequality is satisfied:
0.2<|dA/fA|<3.0
where dA is a distance on the optical axis from a lens surface on a side of the aperture stop of the optical element to the aperture stop, and fA is a focal length of the optical element.

7. The optical system according to claim 1, further comprising an aperture stop,
wherein the following inequality is satisfied:
0.05<dA/OVL|<0.70
where dA is a distance on the optical axis from a lens surface on a side of the aperture stop of the optical element to the aperture stop, and OVL is a distance on the optical axis from the lens surface closest to the object of the optical system to an image plane.

8. The optical system according to claim 1, where the following inequality is satisfied:
1.5<d<4.0
where d is specific gravity of the optical element.

9. The optical system according to claim 1, wherein the optical system includes, in order from the object side to the image side, a first lens unit and a second lens unit, and a distance between the first lens unit and the second lens unit changes during focusing, and
wherein the optical element is provided in the first lens unit or the second lens unit.

10. The optical system according to claim 1, wherein the optical system includes, in order from the object side to the image side, a first lens unit having negative refractive power, and a second lens unit having positive refractive power, and
wherein a distance between the first lens unit and the second lens unit is reduced during zooming from a wide-angle end to a telephoto end.

11. The optical system according to claim 1, wherein the optical system includes, in order from the object side to the image side, a first lens unit having positive refractive power, and a second lens unit having negative refractive power, and
wherein a distance between the first lens unit and the second lens unit is increased during zooming from a wide-angle end to a telephoto end.

12. An image pickup apparatus comprising:
an optical system;
an image sensor configured to receive an image formed by the optical system,
wherein in the optical system, a height from an optical axis of a paraxial marginal ray that passes through a lens surface closest to an object is smaller than a maximum height from the optical axis of the paraxial marginal ray that passes through a lens surface on an image side of an intersection between the optical axis and a paraxial chief ray,
wherein the optical system includes an optical element disposed on an object side or the image side of the intersection,
wherein the optical element has positive refractive power in a case where the optical element is disposed on the object side of the intersection, and has negative refractive power in a case where the optical element is disposed placed on the image side of the intersection, and
wherein the following inequalities are satisfied:
1.70<Nd<1.85
28<νd<39
−0.010<θgF−(0.64168−0.00162×νd)<−0.004
where Nd is a refractive index for d-line of the optical element, νd is an Abbe number of the optical element, and θgF is a partial dispersion ratio for g-line and F-line of the optical element.
